(19) United States
(12) Patent Application Publication
(10) Pub. No.: US 2015/0228029 A1
(43) Pub. Date: Aug. 13, 2015

(54) Apparatus and Method for Payment of Third Party Claims

(71) Applicant: DataPath, Inc., Little Rock, AR (US)

(72) Inventors: Greg Licata, Topsfield, MA (US); David Stair, Maumelle, AR (US); John J. Robbins, JR., Little Rock, AR (US)

(21) Appl. No.: 14/617,848

(22) Filed: Feb. 9, 2015

Related U.S. Application Data
(60) Provisional application No. 61/937,161, filed on Feb. 7, 2014.

(51) Int. Cl. G06Q 40/08

(52) U.S. Cl. CPC G06Q 40/08

(57) ABSTRACT

A method and apparatus facilitates the payment of reimbursements to providers. A computer file with information relevant to the payments is provided, the payments having been approved by an administrator. The providers of services covered by the plan are notified that payments are available. The providers may access their account through a web portal to process the payments. The payments are preferably made my an electronic debit card, but may be made by ACH or paper check.

### REFERENCE TO RELATED CASE

This application claims priority under 35 U.S.C. §119 (e) to provisional application No. 61/937,161 filed on Feb. 7, 2014, the content of which is hereby incorporated by reference in its entirety.

### BACKGROUND OF THE INVENTION

### Field of the Invention

The present invention is directed to the payment of reimbursement claims. Generally, a person secures services and/or goods that are reimbursed. Many times these reimbursements are covered under insurance policy, an account (such as an HSA, FSA, etc.), a self-administered plan, a self-insured plan, etc. A provider, the person or entity providing the goods and/or services, submits a claim for the person in order to receive payment for providing the goods and/or services. The claim is submitted to an administrator or payer, who determines whether the claim made is covered by that administrator. If the claim is adjudicated as being covered, the administrator prints and mails a check to the provider on behalf of the person. Depending upon the size of the administrator, this can amount to thousands of checks needing to be printed and sent on a daily or weekly basis. However, there is a cost associated with the writing and mailing of the check, anywhere between $5 and $15 per claim. These costs increase overhead and reduce the profits of the administrator.

Thus, a more efficient system is needed where the payments to providers can be consolidated and the costs associated with paying the providers is reduced.

### SUMMARY OF THE INVENTION

The present invention is directed to a method of facilitating payments to providers, the method includes receiving a computer file from an administrator containing information related to a plurality of payments, the plurality of payments having been approved by the administrator for reimbursement, notifying the provider that funds corresponding to at least some of the plurality of payments are available to the provider, and providing a web portal for the provider to access a provider account and to process at least one of plurality of payments.

According to another aspect of the present invention, a computer system for facilitating payments to providers is provided, the computer system being adapted for facilitating the receipt of a computer file from a provider containing information related to a plurality of payments, the plurality of payments having been approved for reimbursement, moving funds from one account to another to pay the plurality of payments; notifying the provider that funds corresponding to at least some of the plurality of payments are available to the provider, and allowing the provider to access a provider account through the computer system and to process at least one of plurality of payments to receive the at least one payment.

In yet another aspect, a method of facilitating payments to providers, the method includes receiving a computer file containing information related to a plurality of payments, the plurality of payments having been approved for reimbursement, transferring funds corresponding to the plurality of payments, notifying the provider that funds corresponding to at least some of the plurality of payments are available to the provider, and providing a web portal for the provider to access a provider account and to process at least one of plurality of payments from the holding account.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a block diagram of a third party payment system according to a particular embodiment of the present invention;

FIG. 2 is diagram that visually illustrates the steps in various embodiments of the system according to the present invention;

FIG. 3 depicts a first screen in a web portal for a provider on the payment system according to various embodiments of the present invention;

FIG. 4 depicts a pending payment screen for the provider showing an electronic debit card number for the provider;

FIG. 5 depicts a payment screen for claims for a provider according to various embodiments of the present invention;

FIG. 6 depicts a detailed payment screen for a provider according to various embodiments of the present invention; and

FIG. 7 depicts a payment detail screen him for electronic debit card payments for a provider according to various embodiments of the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

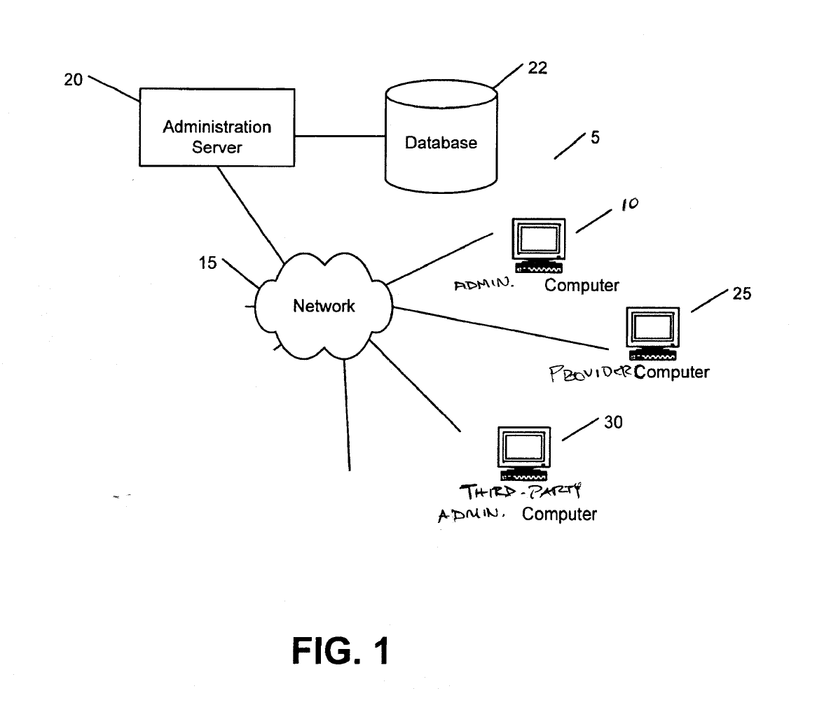

A system 5 according to one embodiment of the invention is shown in FIG. 1. As may be understood from this figure, in this embodiment, the system 5 includes at least one administrator computer 10 that is connected (e.g., via a network 15 such as a LAN or a global communications network, such as the Internet) to communicate with an administration server 20. The system may also include other computers that are connected (e.g., via a network 15 such as a LAN or a global communications network, such as the Internet) to communicate with the administration server 20. Such computers may include, for example: (1) one or more provider computers 25 (e.g., computers that are associated with one or more service providers); (2) one or more third-party administrator computers 30 (e.g., computers that are associated with one or more third-party administrators (TPAs or payers)). The system may be further connected to communicate with one or more other computers as necessary in the same way as the administrator computers 10, the provider computers 25, and the third-party administrator computers 30. The programs and software necessary to perform the functions stated herein reside on the administration server 20.

In one embodiment of the invention, the administration server 20 is configured for retrieving data from, and for saving data to, a database 22 that may be stored on (or, alternatively, stored remotely from) the administration server 20. In the embodiment shown in FIG. 1, the database 22 is maintained on a computer that is remote from the administration server 20.

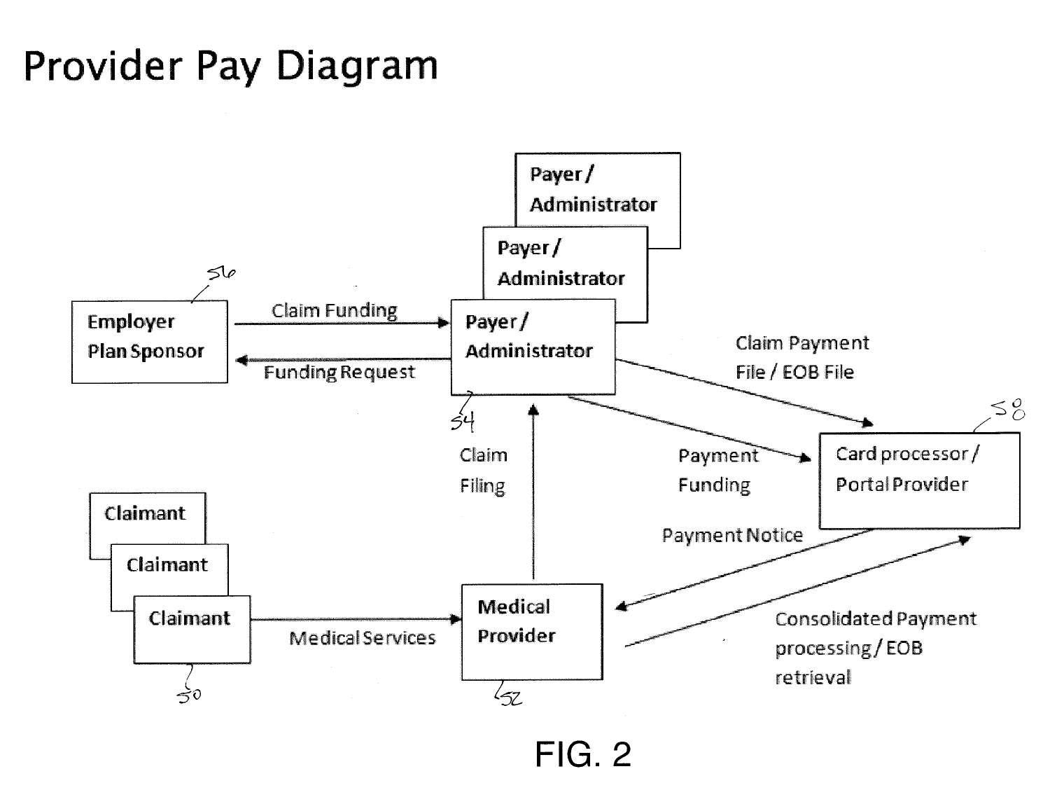

FIG. 2 depicts in a systematic fashion the general flow of activities relevant to the present invention. The activities illustrated are directed to providing medical services, such as group medical, worker's compensation, and dental claims. However, the process may also be used by third-party administrators to facilitate property and casualty insurance claims as well as vendor and attorney payments.

As illustrated in FIG. 2, a claimant (or more than one) 50 receive medical services from a medical provider 52. After providing medical services, the medical provider 52 files a claim with the third-party administrator or payer 54. Based upon the services and the number of claimants, the medical provider 52 may file claims with more than one third-party administrator 54. The third-party administrator 54 is responsible for ensuring that the claims filed by the medical provider 52 are covered and/or reimbursable under the employer plan sponsor 56. As noted above, the sponsor 56 can be an insurance policy, an account (such as an HSA, FSA, etc.), a self-administered plan, a self-insured plan, etc Once the third-party administrator 54 determines that the claim is covered, the third-party administrator 54 submits a funding request to the plan sponsor 56. The plan sponsor 56 provides funding to the third-party administrator 54 to reimburse the medical provider 52 for the claims filed by the medical provider 52. The third-party administrator 54 then provides to the system administrator (identified as card processor/portal provider) 58 a claim payment file. The claim payment file is typically a computer file with relevant data for each of the claims adjudicated by the third-party administrator 54. This data may include the identity of the claimant 50, the medical provider 52, the goods and/or services provided by the provider 52, the amount of the claim, the dates of service, etc. It should be noted that from this data, an explanation of benefits/payments can be generated by the system administrator 58 that meets all requirements for such reports/explanations.

The third-party administrator 54 also sends payment and/or funding for each of the claims in the claim payment file. It should be understood, that the payment funding from the third-party administrator 54 may precede the claim payment file, be done simultaneously, or may come at a later date. If the third-party administrator 54 prefers to send the payment funding at a later time, then the system administrator 58 must either wait to send payment notices or advance the funds on behalf of the third-party administrator 54. Naturally, the parties may make the appropriate arrangements among themselves.

Once the system administrator 58 receives the claim payment file (and also perhaps the funding as discussed above), the system administrator 58 then sends a payment notice to the provider 52. The system administrator 58 may send payment notice to the provider 52 in any number of ways. Preferably, the system administrator 58 sends an e-mail to the provider 52 that payments that are available. The system administrator 58 may also arrange to have the payment notice sent by e-mail or even by snail mail. As discussed in detail below, each of the third-party administrators 54 (and providers 52) an account with system administrator 58 that includes their preferences and their pertinent data (which would include identification information, bank information, supported providers, payment preferences, etc.).

Once the provider 52 is aware of the payment is available, the provider can access a provider account provided by the system administrator 58 through a web portal. The provider 52 can elect to process any or all of the payments that are available through the web portal. In this way, the provider 52 has better control over payments from third-party administrators 54.

Turning now to the details of the system, a third-party administrator 54 creates an account with the system administrator 58. The account for the third-party administrator 54 includes the necessary settings and preferences. The third-party administrator 54 will also establish a network of its providers. As is known in the industry, the third-party administrators 54 work with certain providers and already have the relevant information regarding the providers. Alternatively, the third-party administrators 54 may also choose from a list of providers 52 that have already been entered into the system 5. Again, this process and the payments are applicable outside the medical reimbursement arena as well.

Included in the information that is provided by the third-party administrator 54, is provider payment preferences. The third-party administrator 54 may select to pay the providers 52 by electronic debit card processing system (Provider Pay), by issuing a check, or by ACH. In the present system, electronic debit card processing may be set as the default option. In one embodiment, the system administrator 58 only receives claim payment files from the third-party administrator 54 for those providers who will receive reimbursements by the electronic debit card processing system. In some instances, it can be imagined that the system administrator 58 incurs the same costs in providing a paper check or ACH transfer as does the third-party administrator 54.

The system 5 also allows the third-party administrator 54 to set up a payment model based upon their own needs and requirements. For example, some of the third-party administrators 54 will want the providers to receive the payment notice regarding available payments with a uniquely identified URL (to access the system through a web portal as discussed above). The provider 52 will click on or access the web portal through the URL to see the payments available only from that third-party administrator 54. Alternatively, the third-party administrator could allow providers 52 to see all payments across all of the third-party administrators 54 that work with any one of the providers 52. Additional options and preferences may also be provided to the third-party administrators 54.

Once the third-party administrator 54 has set up their account, the providers 52 associated with the third-party administrators are notified about the new system for payment. As noted above, the providers 52 can be notified by e-mail, facsimile, or snail mail. This may be done directly through the system 5, or by the system administrator 58 or the third-party administrator 54. The providers 52 may log into the system 5 through computers 25 to create a user account, verify their demographics, set preferences, etc. This would also include the way that the provider 52 would prefer to be reimbursed by the third-party administrator 54. The same process occurs for newly added third-party administrators 54. For example, if a new third-party administrator 54 is added to the system, notices are sent to be applicable providers 52, who can log onto the system through their web portal to set up any preferences with that third-party administrator 54.

Once a third-party administrator 54 and the providers 52 have been set up, providers 52 send claims to the third party administrator 54 through their pre-existing claim management system/process. The third-party administrator 54 then processes the claims in its usual way. Once the claims have been released for payment, the third-party administrators 54 will send a claimant payment file to the system administrator 58. The system 5 will process the file to determine the source account identified by the third-party administrator 54 to fund the payments. For example, the third-party administrator 54 may designate a third party administrator owned account, and employer owned account, or a combination of the two.

If the third-party administrator 54 is providing funds to the system administrator 58, the system 5 will then generate ACH transactions to transfer the funds to the system administrator 58. The system administrator 58 will then review the payment indicators associated with each payment in the claim payment file. If the third-party administrator 54 has identified a preferred payment method for the provider 52, the payment will be made in that format. If there is no information the claim payment file, the default method identified by the third-party administrator 54 in their account on system 5 will be used to make the payment. As noted above, it is possible that the system administrator 58 use it's own funds to make the payments associated with any claim payment file and then to be reimbursed by the third-party administrator 54 at a later date.

The third-party administrator 54 may also have a third-party review the payments identified in the claim payment of file forwarded to the administrator 58. For example, the third-party administrator 54 may have all claims over a certain dollar amount be reviewed prior to making payments. The third-party administrator 54 may use a contract company to perform the review. Alternatively, the third-party administrator 54 may have had the claim payment file assembled by a third-party and want to review any claims in the claim payment file that meet a certain criteria. The system 5 and the system administrator 58 is able to accommodate any such request by a third-party administrator 54 based upon information contained in the claim payment file.

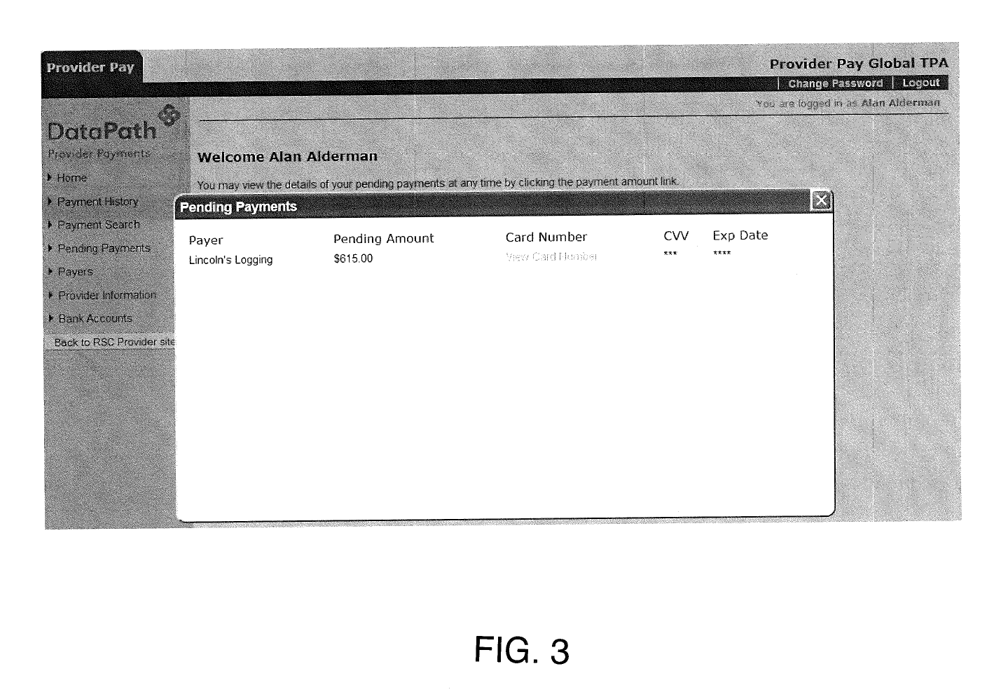

Reference will now be made to FIG. 3 to explain the payment process. As noted above, one of the preferred methods of payment is an electronic debit card. When payment is made in an electronic debit card manner, the system 5 will generate a card number, the CVV, and an expiration date for the card.

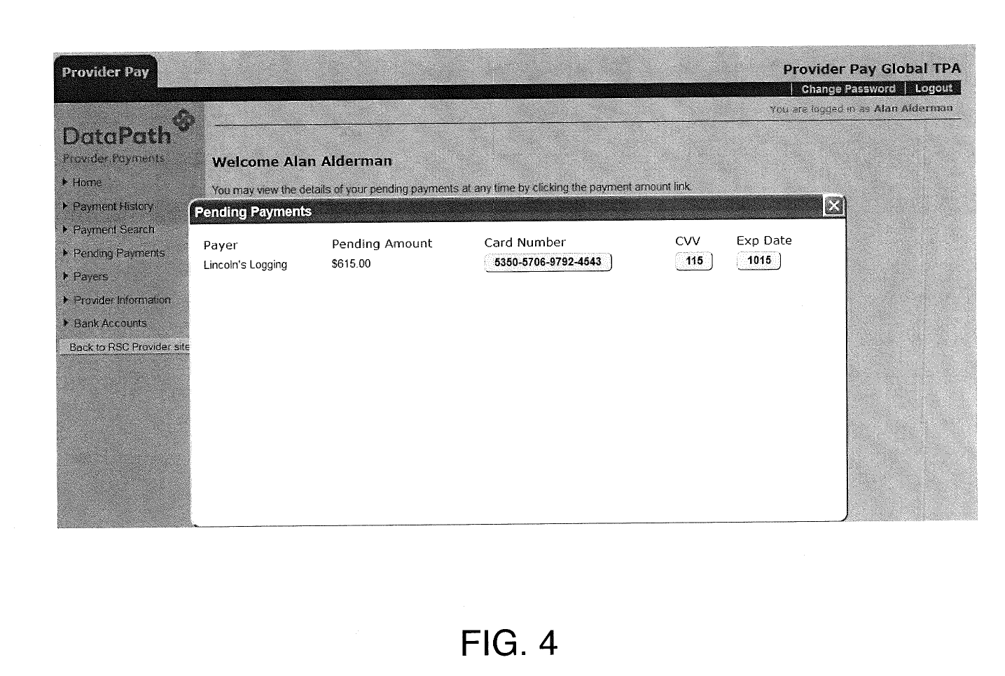

FIG. 3 depicts a provider's 52 first screen after logging into the system 5. As illustrated, there is a pending payment for $615 by Provider Pay or as an electronic debit card. The provider 52 may click on the “View Card Number” to see the card number generated for this payment. Turning to FIG. 4 where the provider 52 has clicked on the link, the card number, the CVV, and the expiration date are shown. The provider 52 may then enter the card number, CVV, and the expiration date into its merchant terminal to receive the $615 payment. The electronic debit card may be a single use debit card or may allow for multiple payments. Additionally, it should be noted that if there are pending payments for a provider 52, and any additional payments become available, the additional payments may be added to an electronic debit card that has already had its number generated.

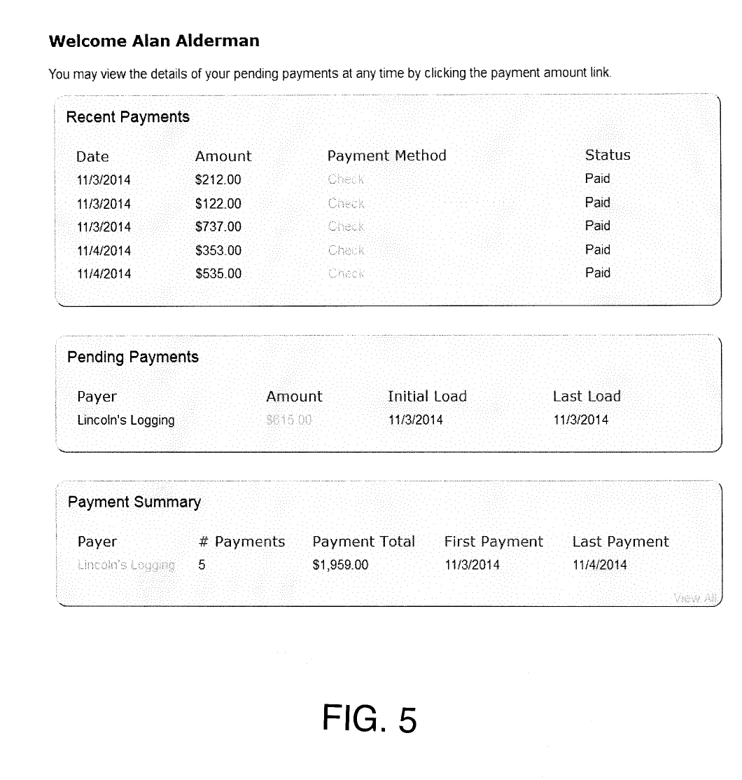

It should be noted that for all payments made by check or by ACH transactions from the third-party administrator 54 or the system administrator 58 to the providers 52 no notice will be sent to the providers 52 since the provider will receive a check in the first instance and the deposit in their bank account in the second. However, as illustrated in FIG. 5 the payments may be identified in the account for provider 52. This would make reconciliation easier for the providers 52 when they receive a check or funds by ACH.

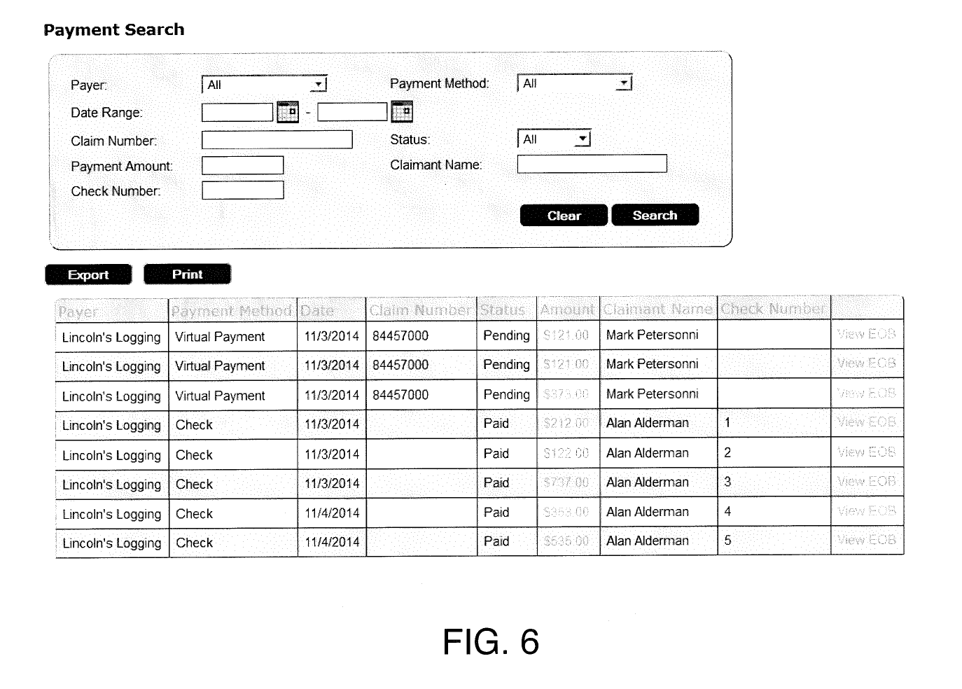

Additionally, as seen in the detailed payment screen in FIG. 6, the provider has access to more information about each payment. On the far right of the screen, the provider may click on the link to “view EOB” to see even more details regarding the payment. The EOB is generated by the system 5 from the data contained in the claim payment file.

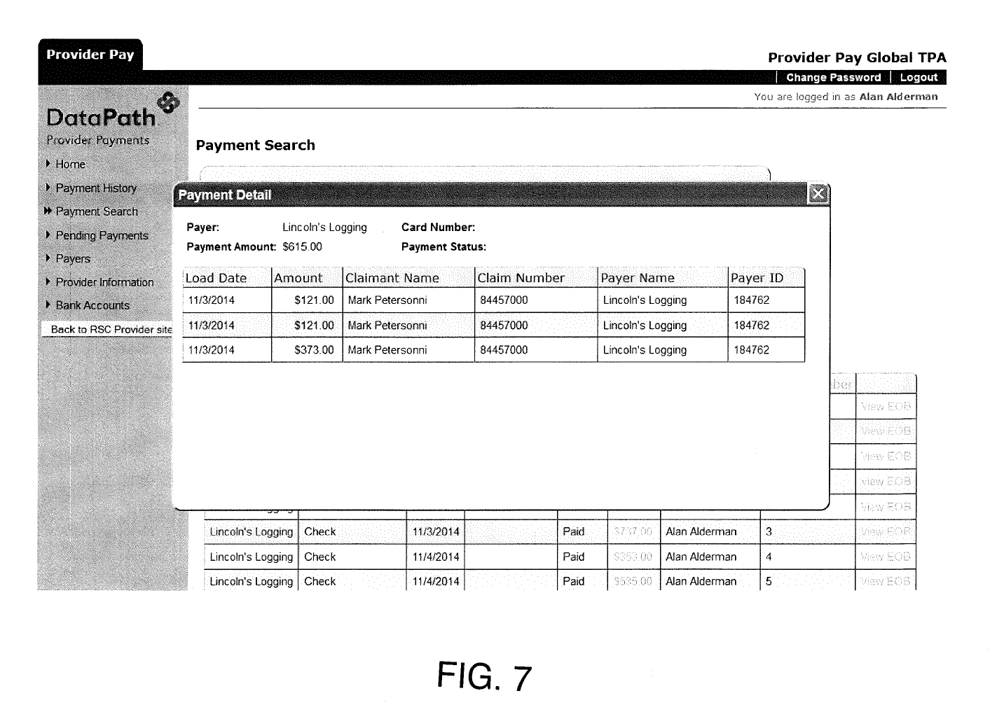

As illustrated in FIG. 7 the details of specific payments can also be viewed. For example, FIG. 7 illustrates the specific data for the payment of $615 in FIG. 4.

If a provider 52 fails to process a payment within 15 days from the first notification (or any other value provided for by the third-party administrator 54 in the third-party administrator's 54 account), a second notification is sent to the provider 52 regarding any pending payments. If the provider still has not processed the payment within 90 days, the system administrator 58 may generate a paper check or ACH deposit. Alternatively, the system administrator 58 may notify the third-party administrator 54 that payment was not made and the third-party administrator 54 can make alternate payment arrangements.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A method of facilitating payments to providers, the method comprising:
receiving a computer file from an administrator containing information related to a plurality of payments, the plurality of payments having been approved by the administrator for reimbursement;
notifying the provider that funds corresponding to at least some of the plurality of payments are available to the provider; and
providing a web portal for the provider to access a provider account and to process at least one of plurality of payments.

2. The method according to claim 1, further comprising making funds available that correspond to at least some of the plurality of payments.

3. The method according to claim 2, wherein the funds are provided by the administrator before the notifying of the provider.

4. The method according to claim 2, wherein the funds are provided by a party other than the administrator before the notifying of the provider.

5. The method according to claim 4, wherein the administrator reimburses the other party.

6. The method according to claim 1, wherein the provider may also view an explanation of the plurality of payments through the web portal.

7. The method according to claim 1, wherein the step of notifying the provider is performed by at least one of facsimile, email, or mail.

8. The method according to claim 1, wherein the step of processing the at least one payment comprises the options of an electronic debit card, ACH transfer, and paper check.

9. The method according to claim 1, wherein the step of processing the at least one payment comprises processing a plurality of payments.

10. The method according to claim 2, wherein the funds are provided by the administrator before the notifying of the provider.

11. The method according to claim 1, further comprising the step of providing access through a web portal to data in the computer file for review by a third party before notifying the provider that funds are available.

12. A computer system for facilitating payments to providers, the computer system being adapted for:
facilitating the receipt of a computer file from an administrator containing information related to a plurality of payments, the plurality of payments having been approved for reimbursement;
moving funds from one account to another to pay the plurality of payments;
notifying the provider that funds corresponding to at least some of the plurality of payments are available to the provider; and
allowing the provider to access a provider account through the computer system and to process at least one of plurality of payments to receive the at least one payment.

13. The computer system according to claim 12, wherein the payment is a electronic payment made through a virtual debit card.

14. The computer system according to claim 12, wherein notifying the provider is performed by at least one of facsimile, email, or mail.

15. A method of facilitating payments to providers, the method comprising:
receiving a computer file containing information related to a plurality of payments, the plurality of payments having been approved for reimbursement;
transferring funds corresponding to the plurality of payments;
notifying the provider that funds corresponding to at least some of the plurality of payments are available to the provider; and
providing a web portal for the provider to access a provider account and to process at least one of plurality of payments from the holding account.

16. The method according to claim 15, wherein the step of transferring funds comprises moving funds from an administrator to a holding account.
